(19) United States
(12) Patent Application Publication
(10) Pub. No.: US 2020/0369072 A1
(43) Pub. Date: Nov. 26, 2020

(54) Seam Cutting Assembly

(71) Applicant: Ronald Williams, Sandy, UT (US)

(72) Inventor: Ronald Williams, Sandy, UT (US)

(21) Appl. No.: 16/418,442

(22) Filed: May 21, 2019

(51) Int. Cl. B44C 7/02; B26B 5/00

(52) U.S. Cl. CPC B44C 7/025; B26B 5/006; B26B 5/005

(57) ABSTRACT

A seam cutting assembly includes a holder that has a blade slot therein, a cutting space and a hooked end extending partially across the cutting space. The hooked end abuts a wall having a wall covering being positioned in the cutting space. A blade is provided and the blade is slidable into the blade slot. The blade extends into the cutting space when the blade is positioned in the blade slot for cutting the wall covering. The hooked end is positioned beneath the blade when the blade is inserted into the blade slot to inhibit the blade from cutting the wall. A sleeve is slidable over the holder and the blade when the blade is positioned in the blade slot such that the sleeve retains the blade in the blade slot.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to cutting devices and more particularly pertains to a new cutting device for cutting a wall covering while avoiding cutting a wall.

### BRIEF SUMMARY OF THE INVENTION

An embodiment of the disclosure meets the needs presented above by generally comprising a holder that has a blade slot therein, a cutting space and a hooked end extending partially across the cutting space. The hooked end abuts a wall having a wall covering being positioned in the cutting space. A blade is provided and the blade is slidable into the blade slot. The blade extends into the cutting space when the blade is positioned in the blade slot for cutting the wall covering. The hooked end is positioned beneath the blade when the blade is inserted into the blade slot to inhibit the blade from cutting the wall. A sleeve is slidable over the holder and the blade when the blade is positioned in the blade slot such that the sleeve retains the blade in the blade slot.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a seam cutting assembly according to an embodiment of the disclosure.

FIG. 2 is an exploded perspective view of an embodiment of the disclosure.

FIG. 3 is an exploded left side view of an embodiment of the disclosure.

FIG. 4 is a top view of an embodiment of the disclosure.

FIG. 5 is a phantom left side view of an embodiment of the disclosure.

FIG. 6 is a perspective in-use view of an embodiment of the disclosure.

### DETAILED DESCRIPTION OF THE INVENTION

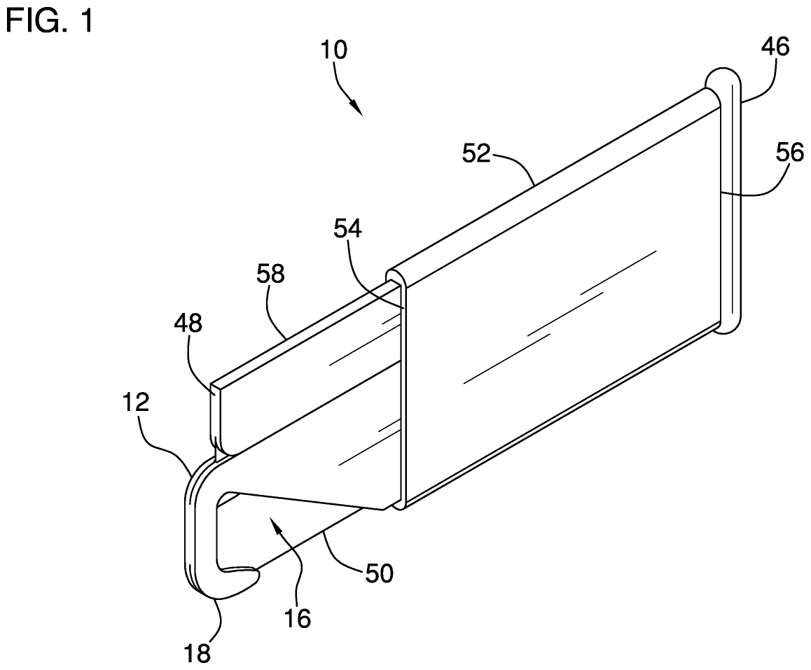

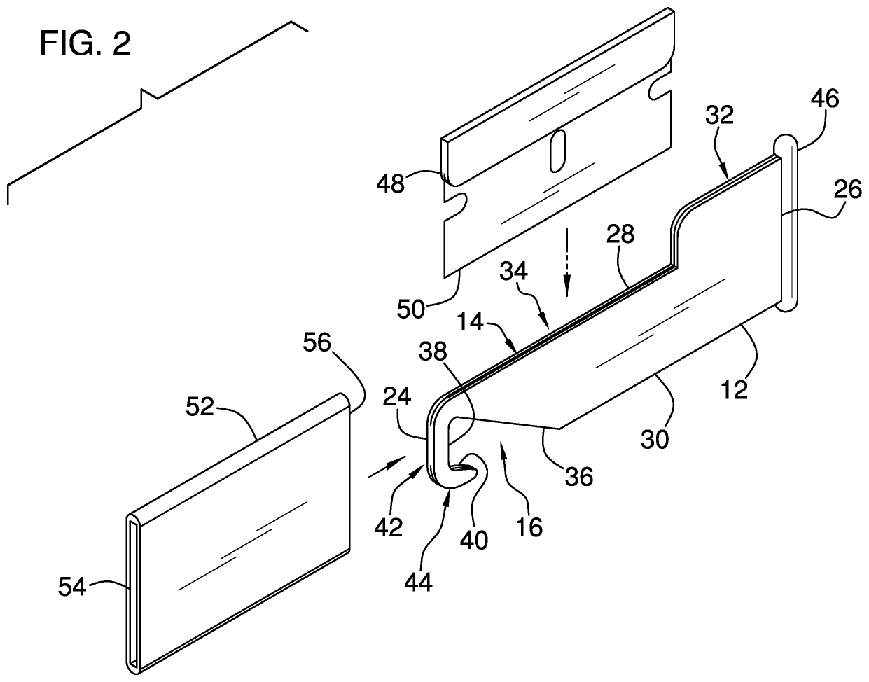

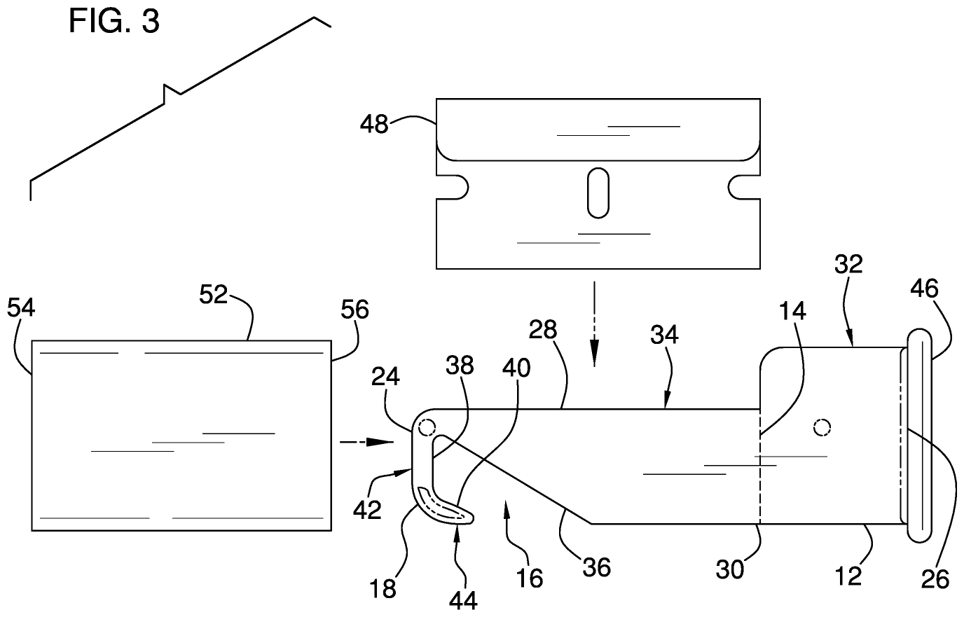

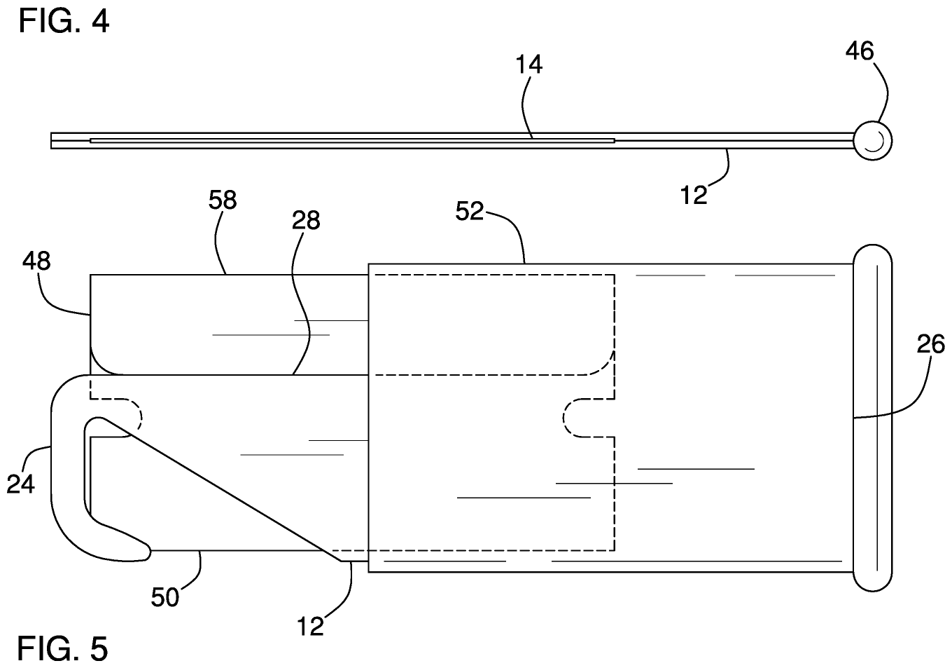

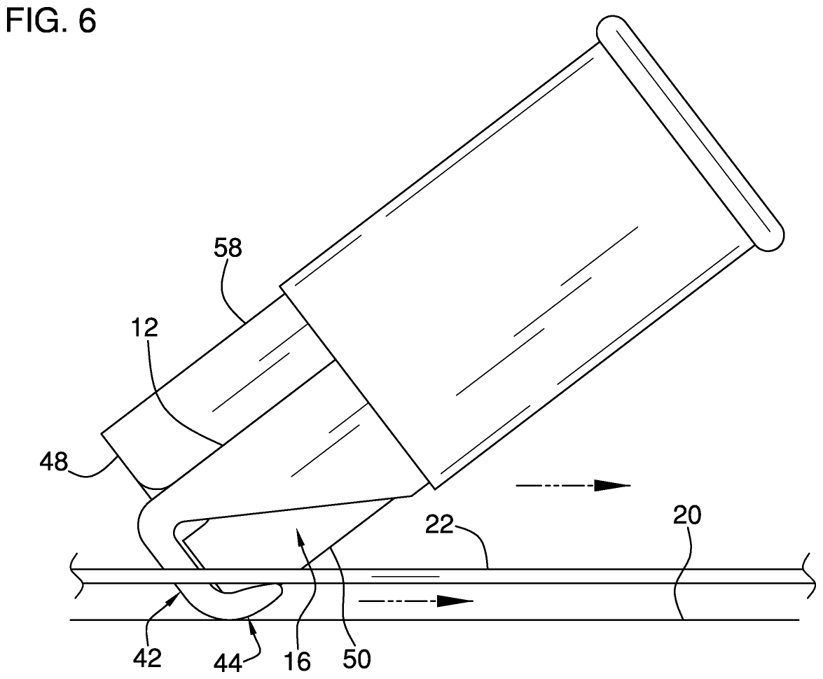

With reference now to the drawings, and in particular to FIGS. 1 through 6 thereof, a new cutting device embodying the principles and concepts of an embodiment of the disclosure and generally designated by the reference numeral 10 will be described.

As best illustrated in FIGS. 1 through 6, the seam cutting assembly 10 generally comprises a holder 12 that has a blade slot 14 therein, a cutting space 16 and a hooked end 18 extending partially across the cutting space 16. The hooked end 18 abuts a wall 20 having a wall covering 22 being positioned in the cutting space 16. The wall 20 may be a wall 20 in a room of a house and the wall covering 22 may be wall paper, vinyl or any other type of flexible sheet used as wall covering. The holder 12 has a first end 24, a second end 26, a top edge 28 and a bottom edge 30. The top edge 28 has a raised portion 32 extending from the first end 24 toward the second end 26 and a lowered portion 34 extending between the raised portion 32 and the second end 26.

The blade slot 14 extends through the top 28 and bottom 30 edges. Moreover, the blade slot 14 is coextensive with the lowered portion 34 of the top edge 28 and terminates at the raised portion 32. The cutting space 16 extends from the bottom edge 30 toward the lowered portion 34 of the top edge 28. The cutting space 16 has a back bounding edge 36, a top bounding edge 38 and a front bounding edge 40. The back bounding edge 36 angles upwardly from the bottom edge 30 of the holder 12 toward the second end 26 of the holder 12. The front bounding edge 40 angles upwardly from the bottom edge 30 of the holder 12 toward the second end 26 of the holder 12. The top bounding edge 38 extends downwardly between the front 40 and back 36 bounding edges to define the hooked end 18 of the holder 12.

The hooked end 18 comprises a leg 42 extending downwardly along the second end 26 of the holder 12 and a foot 44 that is aligned with the bottom edge 30 of the holder 12. The foot 44 is directed toward the first end 24 of the holder 12. The foot 44 rests against the wall 20 having the wall covering 22 extending into the cutting space 16. A stop 46 is coupled to the second end 26 of the holder 12. The stop 46 is dimensionally greater than the second end 26 of the holder 12 and the stop 46 is coextensive with the second end 26.

A blade 48 is provided and the blade 48 is slidable into the blade slot 14. The blade 48 extends into the cutting space 16 when the blade 48 is positioned in the blade slot 14. In this way the blade 48 is positioned to cut the wall covering 22. The hooked end 18 is positioned beneath the blade 48 when the blade 48 is inserted into the blade slot 14. In this way the hooked end 18 inhibits the blade 48 from cutting the wall 20. The blade 48 may be a disposable razor blade 48 or the like.

The blade 48 has a cutting edge 50 and the cutting edge 50 is aligned with the bottom edge 30 of the holder 12 when the blade 48 is positioned in the blade slot 14. Moreover, the cutting edge 50 extends between the foot 44 and the back bounding edge 36 of the cutting space 16 when the blade 48 is positioned in the blade slot 14. The blade 48 abuts the raised portion 32 of the top edge 28 when the blade 48 is positioned in the blade slot 14 such that the blade 48 is inhibited from sliding rearwardly in the holder 12.

A sleeve 52 is slidable over the holder 12 and the blade 48 when the blade 48 is positioned in the blade slot 14 such that the sleeve 52 retains the blade 48 in the blade slot 14. The sleeve 52 has a front end 54 and a back end 56. The back end 56 abuts the stop 46 on the holder 12 when the sleeve 52 is slid over the holder 12. Additionally, the front end 54 is spaced from the back bounding edge 36 of the cutting space 16 when the sleeve 52 is slid over the holder 12 thereby exposing the cutting edge 50 of the blade 48. An upper edge 58 of the blade 48 engages the sleeve 52 when the sleeve 52 is slid over the holder 12 thereby retaining the blade 48 in the blade slot 14.

In use, the blade 48 is inserted into the blade slot 14 and the sleeve 52 is slid over the holder 12 to retain the blade 48 in the blade slot 14. The handle is gripped and the foot 44 is positioned against the wall 20 into a previously made cut in an upper edge of the wall covering 22. The holder 12 is urged downwardly along the wall 20. In this way the foot 44 slides against the wall 20 and beneath the wall covering 22. Moreover, the cutting edge 50 of the blade 48 cuts the wall covering 22 as the handle is urged downwardly.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A seam cutting assembly being configured to cut a seam in wall covering without cutting a wall, said assembly comprising:
a holder having a blade slot therein, a cutting space and a hooked end extending partially across said cutting space wherein said hooked end is configured to abut a wall having a wall covering being positioned in said cutting space, said holder having a first end, a second end, a top edge and a bottom edge, said top edge having a raised portion extending from said second end toward said first end and a lowered portion extending between said raised portion and said first end, said blade slot extending through said top and bottom edges, said blade slot being coextensive with said lowered portion of said top edge and terminating at said raised portion, said cutting space extending from said bottom edge toward said lowered portion of said top edge, said cutting space having a back bounding edge, a top bounding edge and a front bounding edge, said back bounding edge angling upwardly from said bottom edge of said holder toward said first end of said holder, said front bounding edge angling upwardly from said bottom edge of said holder toward said first end of said holder, said top bounding edge extending downwardly between said front and back bounding edges to define said hooked end of said holder, said hooked end comprising a leg extending downwardly along said first end of said holder and a foot being aligned with said bottom edge of said holder and being directed toward said second end of said holder wherein said foot is configured to rest against a wall having a wall covering extending into said cutting space;
a blade being slidable into said blade slot, said blade extending into said cutting space when said blade is positioned in said blade slot wherein said blade is configured to cut the wall covering, said hooked end being positioned beneath said blade when said blade is inserted into said blade slot wherein said hooked end is configured to inhibit the blade from cutting the wall, said blade having a cutting edge, said cutting edge being aligned with said bottom edge of said holder when said blade is positioned in said blade slot, said cutting edge extending between said foot and said back bounding edge of said cutting space when said blade is positioned in said blade slot, said blade abutting said raised portion of said top edge when said blade is positioned in said blade slot such that said blade is inhibited from sliding rearwardly in said holder; and
a sleeve being slidable over said holder and said blade when said blade is positioned in said blade slot such that said sleeve retains said blade in said blade slot, said sleeve having a front end and a back end, said back end abutting a stop on said holder when said sleeve is slid over said holder, said front end being spaced from said back bounding edge of said cutting space when said sleeve is slid over said holder thereby exposing said cutting edge of said blade, an upper edge of said blade engaging said sleeve when said sleeve is slid over said holder thereby retaining said blade in said blade slot.

2. (canceled)

3. (canceled)

4. (canceled)

5. The assembly according to claim 1, further comprising said stop being coupled to said second end of said holder, said stop being dimensionally greater than said second end of said holder.

6. (canceled)

7. (canceled)

8. A seam cutting assembly being configured to cut a seam in wall covering without cutting a wall, said assembly comprising:
a holder having a blade slot therein, a cutting space and a hooked end extending partially across said cutting space wherein said hooked end is configured to abut a wall having a wall covering being positioned in said cutting space, said holder having a first end, a second end, a top edge and a bottom edge, said top edge having a raised portion extending from said second end toward said first end and a lowered portion extending between said raised portion and said first end, said blade slot extending through said top and bottom edges, said blade slot being coextensive with said lowered portion of said top edge and terminating at said raised portion, said cutting space extending from said bottom edge toward said lowered portion of said top edge, said cutting space having a back bounding edge, a top bounding edge and a front bounding edge, said back bounding edge angling upwardly from said bottom edge of said holder toward said first end of said holder, said front bounding edge angling upwardly from said bottom edge of said holder toward said first end of said holder, said top bounding edge extending downwardly between said front and back bounding edges to define said hooked end of said holder, said hooked end comprising a leg extending downwardly along said first end of said holder and a foot being aligned with said bottom edge of said holder and being directed toward said second end of said holder wherein said foot is configured to rest against a wall having a wall covering extending into said cutting space;
a stop being coupled to said second end of said holder, said stop being dimensionally greater than said second end of said holder, said stop being coextensive with said second end;
a blade being slidable into said blade slot, said blade extending into said cutting space when said blade is positioned in said blade slot wherein said blade is configured to cut the wall covering, said hooked end being positioned beneath said blade when said blade is inserted into said blade slot wherein said hooked end is configured to inhibit the blade from cutting the wall, said blade having a cutting edge, said cutting edge being aligned with said bottom edge of said holder when said blade is positioned in said blade slot, said cutting edge extending between said foot and said back bounding edge of said cutting space when said blade is positioned in said blade slot, said blade abutting said raised portion of said top edge when said blade is positioned in said blade slot such that said blade is inhibited from sliding rearwardly in said holder; and
a sleeve being slidable over said holder and said blade when said blade is positioned in said blade slot such that said sleeve retains said blade in said blade slot, said sleeve having a front end and a back end, said back end abutting said stop on said holder when said sleeve is slid over said holder, said front end being spaced from said back bounding edge of said cutting space when said sleeve is slid over said holder thereby exposing said cutting edge of said blade, an upper edge of said blade engaging said sleeve when said sleeve is slid over said holder thereby retaining said blade in said blade slot.

9. A seam cutting assembly being configured to cut a seam in wall covering without cutting a wall, said assembly comprising:
a holder having a blade slot therein, a cutting space and a hooked end extending partially across said cutting space wherein said hooked end is configured to abut a wall having a wall covering being positioned in said cutting space, said holder having a first end, a second end, a top edge and a bottom edge, said cutting space having a back bounding edge, a top bounding edge and a front bounding edge, said back bounding edge angling upwardly from said bottom edge of said holder toward said first end of said holder;
a stop being coupled to said second end of said holder,
a blade being slidable into said blade slot, said blade extending into said cutting space when said blade is positioned in said blade slot wherein said blade is configured to cut the wall covering, said hooked end being positioned beneath said blade when said blade is inserted into said blade slot wherein said hooked end is configured to inhibit the blade from cutting the wall; and
a sleeve being slidable over said holder and said blade when said blade is positioned in said blade slot such that said sleeve retains said blade in said blade slot, said sleeve having a front end and a back end, said back end abutting said stop on said holder when said sleeve is slid over said holder, said front end being spaced from said back bounding edge of said cutting space when said sleeve is slid over said holder thereby exposing said cutting edge of said blade, an upper edge of said blade engaging said sleeve when said sleeve is slid over said holder thereby retaining said blade in said blade slot.

10. The assembly according to claim 9, wherein said top edge has a raised portion extending from said second end toward said first end and a lowered portion extending between said raised portion and said first end, said blade slot extending through said top and bottom edges, said blade slot being coextensive with said lowered portion of said top edge and terminating at said raised portion.

11. The assembly according to claim 10, wherein said cutting space extends from said bottom edge toward said lowered portion of said top edge, said front bounding edge angling upwardly from said bottom edge of said holder toward said first end of said holder, said top bounding edge extending downwardly between said front and back bounding edges to define said hooked end of said holder.

12. The assembly according to claim 11, wherein said hooked end comprises a leg extending downwardly along said first end of said holder and a foot being aligned with said bottom edge of said holder and being directed toward said second end of said holder wherein said foot is configured to rest against a wall having a wall covering extending into said cutting space.

13. The assembly according to claim 12, further comprising said stop being dimensionally greater than said second end of said holder, said stop being coextensive with said second end.

14. The assembly according to claim 12, wherein said blade has a cutting edge, said cutting edge being aligned with said bottom edge of said holder when said blade is positioned in said blade slot, said cutting edge extending between said foot and said back bounding edge of said cutting space when said blade is positioned in said blade slot, said blade abutting said raised portion of said top edge when said blade is positioned in said blade slot such that said blade is inhibited from sliding rearwardly in said holder.
